(19) United States
(12) Patent Application Publication
(10) Pub. No.: US 2017/0363356 A1
(43) Pub. Date: Dec. 21, 2017

(54) Apparatus For Rapid Cooling Of Substrates Utilizing A Flat Plate And Cooling Channels

(71) Applicant: Palomar Technologies, Inc., Carlsbad, CA (US)

(72) Inventors: Saeed Sedehi, Orange, CA (US); Daniel Ross, Covina, CA (US)

(73) Assignee: Palomar Technologies, Inc., Carlsbad, CA (US)

(21) Appl. No.: 15/626,719

(22) Filed: Jun. 19, 2017

Related U.S. Application Data
(60) Provisional application No. 62/351,817, filed on Jun. 17, 2016.

(51) Int. Cl. F27D 9/00; F27D 7/06

(52) U.S. Cl. CPC F27D 9/00; F27D 7/06; F27D 2009/0083; F27D 2009/007

(57) ABSTRACT

A vacuum pressure furnace and/or a cooling plate for a vacuum pressure furnace is described, having a cooling channel or tube that selectively circulates a liquid coolant at a reduced temperature. The cooling channel “snakes” back and forth through a target plate assembly to conduct heat from the target plate assembly and back to the coolant. The target plate assembly includes a plurality of clamp members that are screwed over portions of the cooling channel and to a bottom of a plate member of the assembly, enclosing portions of the cooling channel. Thermal sheets or foil are wrapped around the cooling channel, thereby bridging any gaps between the components that may occur during temperature changes due to thermal expansion/contraction.

### RELATED APPLICATIONS

This application claims priority to U.S. Provisional Application Ser. No. 62/351,817 filed Jun. 17, 2016 entitled Apparatus for Rapid Cooling of Substrates Utilizing a Flat Plate and Cooling Channels, which is hereby incorporated herein by reference in its entirety.

### BACKGROUND OF THE INVENTION

Vacuum pressure furnaces allow a workpiece to be heated and cooled in various pressure environments, and can be used for a variety of purposes, including the production of electronics. These vacuum pressure furnaces can be particularly useful in achieving void-free die soldering of electronic components, as well as hermetic package sealing of electrical circuit components. Hermetic package sealing typically uses glass, ceramic, or metal (e.g., solder) to create a barrier to gas, preventing moisture or other harmful agents from otherwise damaging sensitive electrical circuit components.

Vacuum pressure furnaces often have a computer control system that is connected to a heating system, a cooling system, and a pressure-vacuum system of a furnace chamber. In some furnace designs, the furnace chamber has a bottom target plate on which one or more workpieces are placed. Such a plate is heated via heating elements (e.g., on the walls of the furnace chamber) and may optionally include a cooling system comprising a cooling pipe or channel containing circulating, temperature-controlled medium. In this regard, the computer system can selectively heat and cool an electronic workpiece within a pressure-controlled environment (e.g., from a vacuum to high pressure).

Since many electronics with hermetic packaging are formed in a full vacuum, the heat transfer mechanism of the furnace occurs almost entirely through radiation between the heating elements or target plate, and the electronic workpiece. While the heating elements can be quickly and readily heated up to provide direct radiant energy to the electronic workpiece, the target plate relies on conduction heat transfer between the plate and the cooling channel. Hence, to achieve relatively quick, efficient heat transfer, good contact between the cooling channel and the target plate is necessary.

Prior furnaces have relied on joining the cooling channel and the target plate using mechanical brazing or welding. Some applications of the furnace require relatively fast cooling of the joining solders and pastes used to join substrates layers of the electronic workpiece. However, the rapid heating and cooling creates a significant amount of stress on the mechanical brazing or welded joints between the target plate and the cooling channel. For that reason, many prior art furnaces rely on separate chambers for rapid heating and cooling.

For example, U.S. Pat. No. 6,796,483 filed Sep. 28, 2004, which is incorporated herein in its entirety, describes a furnace (oven) design with a different station for rapid cooling of an electronic workpiece. As discussed below, the present invention uses a novel method of cooling which is different than this invention.

### SUMMARY OF THE INVENTION

One embodiment is directed to a vacuum pressure furnace and/or a cooling plate for a vacuum pressure furnace. A cooling channel or tube selectively circulates a liquid coolant at a reduced temperature. The cooling channel is positioned in an undulating or alternating wave-like pattern through a target plate assembly to conduct heat from the target plate assembly and back to the coolant. The target plate assembly includes a plurality of clamp members that are screwed over portions of the cooling channel and to a bottom of a plate member of the assembly, enclosing portions of the cooling channel. Thermal sheets or foil are wrapped around the cooling channel, between the clamp member and the plate member, thereby bridging any gaps between the components that may occur during temperature changes due to thermal expansion/contraction.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which:

FIG. 1 a view of a vacuum pressure furnace according to the present invention.

FIG. 2 illustrates a view of a vacuum pressure furnace according to the present invention.

FIG. 3 illustrates a view of a furnace chamber for a vacuum pressure furnace according to the present invention.

FIG. 4 illustrates a view of a furnace chamber for a vacuum pressure furnace according to the present invention.

FIG. 5 illustrates a view of a target plate with a cooling channel according to the present invention.

FIG. 6 illustrates a view of a target plate with a cooling channel according to the present invention.

FIG. 7 illustrates a cross-sectional view of a tare plate according to the present invention.

FIG. 8 illustrates a view of a clamp member for a plate assembly according to the present invention.

FIG. 9 illustrates a view of a clamp member for a plate assembly according to the present invention.

FIG. 10 illustrates a plate member of a plate assembly according to the present invention.

FIG. 11 illustrates a cooling channel according to the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

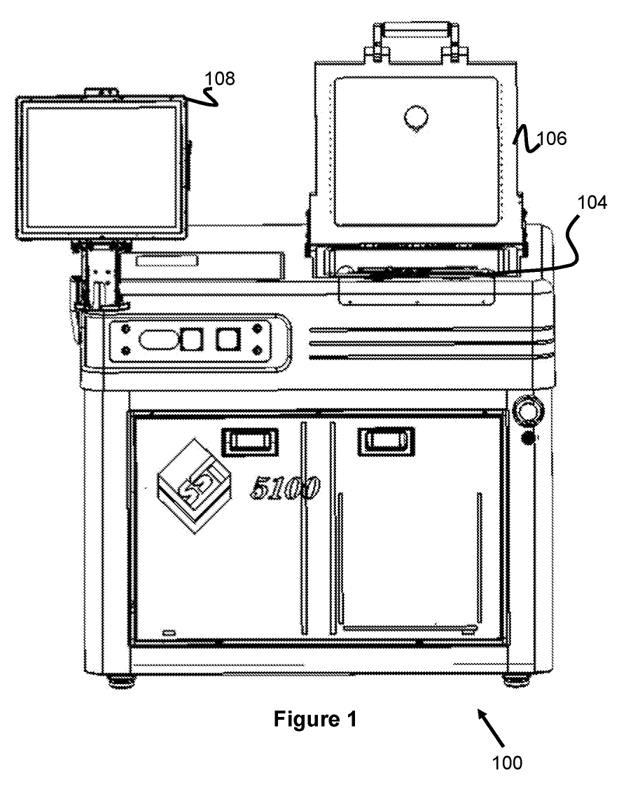

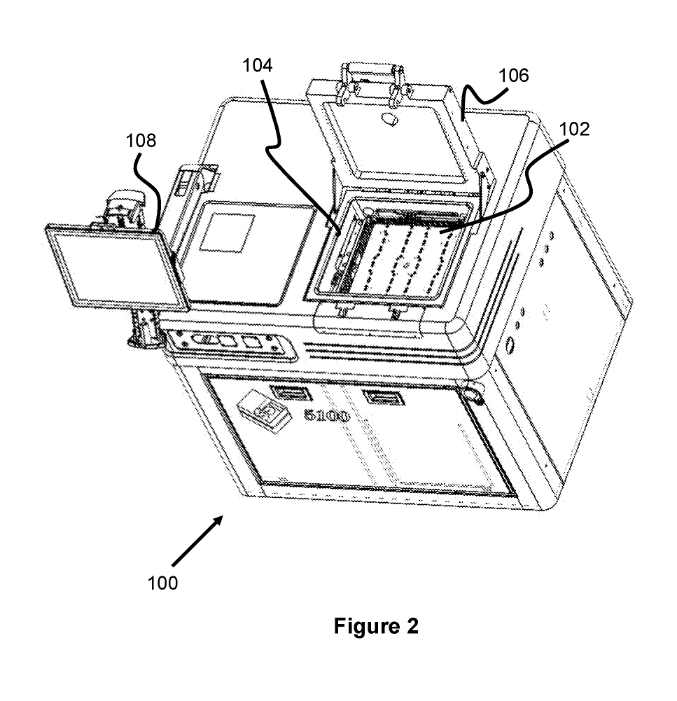

In one embodiment, the present invention is directed to a vacuum pressure furnace 100 that can more efficiently cool down its furnace chamber 104 while maintaining a higher reliability of the its cooling system. As seen in FIGS. 1 and 2, the furnace 100 includes a furnace chamber 104 and a lid 106 that closes over and seals the furnace chamber 104. A user interface 108 (e.g., a display and keyboard) allows a user to program a sequence of conditions (or combination thereof) within the furnace chamber, such as a period of increased temperature, a period of cooling, a period of vacuum (low pressure), and a period of high pressure.

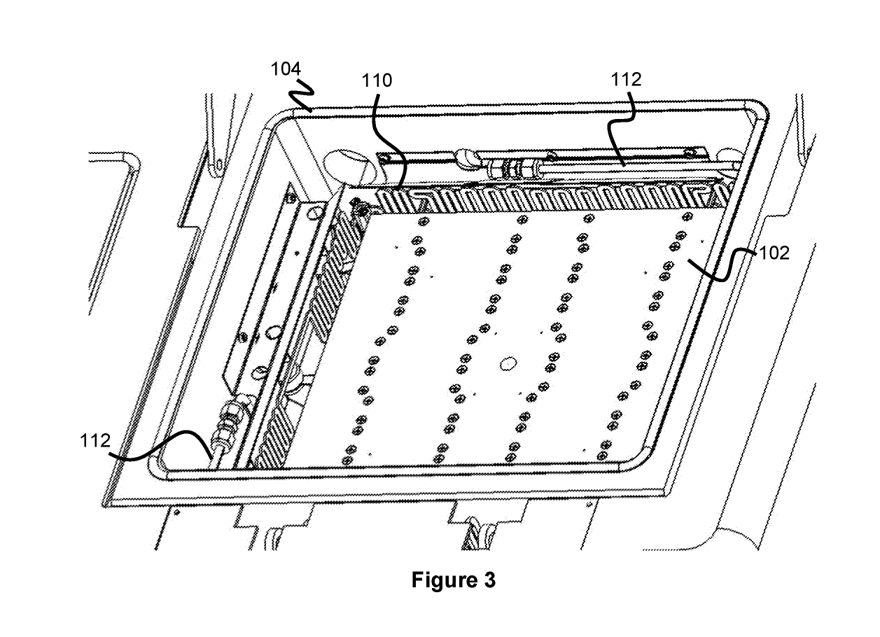

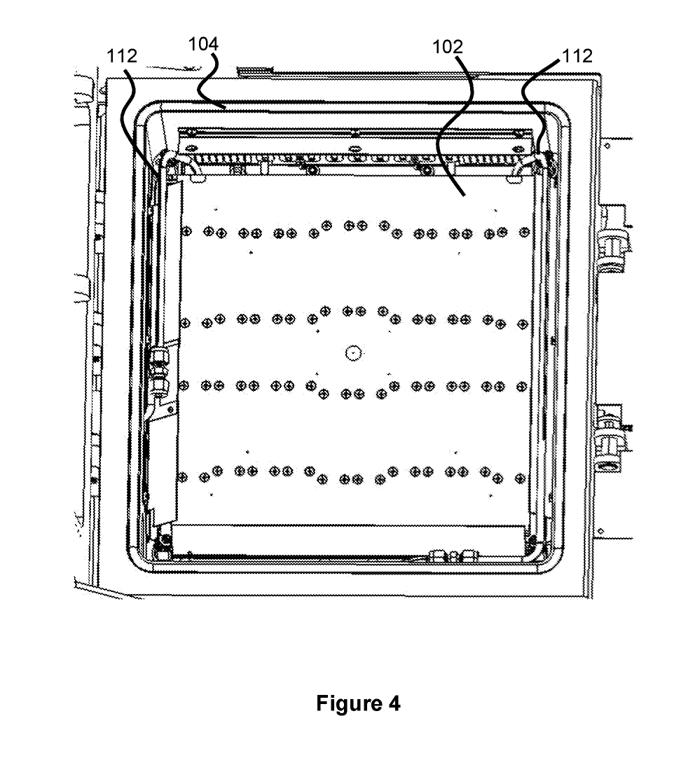

As best seen in FIGS. 3 and 4, the furnace chamber 104 includes a target plate 102 on which one or more electronic workpieces (e.g., an electronic sensor component) can be placed. Heating elements 110 are located along each of the walls of the furnace chamber 104 to provide a desired amount of heat to the target plate 102 and the workpiece.

The pressure within the chamber 104 can be adjusted by a pressure controller which is connected to and controls a vacuum pump, an attached gas supply, and valves capable of adjusting the chamber 104 between a vacuum, ambient atmospheric pressure, and high pressure. Different types of gas (e.g., nitrogen, argon, and helium) are also commonly used in the chamber 104 during operation.

Cooling within the chamber 104 occurs when a liquid or air cooling media is pumped or otherwise circulated through the tubular cooling channel 112. The cooling channel 112 extends through the plate assembly 102 at the base of the chamber 104 and further extends out of the chamber 104 to a pumping mechanism (e.g., a fluid pump) and a heat exchanger. Hence, cool media is passed through the plate assembly 102 and furnace chamber 104, thereby decreasing the temperature of the plate assembly 102; then passes back to the heat exchanger which again decreases the media's temperature. Preferably, the cooling channel 112 is generally tubular and composed of a heat tolerant metal. While the cooling channel 112 is described as a single tubular channel loop, it should be understood that several, separate cooling loops are also possible.

Since the plate assembly 102 and cooling channel 112 are subject to rapid heating and cooling, they tend to expand and shrink, depending on the temperature. For example, the plate assembly 102 may increase/decrease in length, width, and height, and the cooling channel 112 may increase/decrease radially and along its length. Additionally, if the cooling channel 112 and plate assembly 102 are composed of different material, they may increase/decrease in size at different rates due to differences in their coefficient of thermal expansion. This difference in expansion/contraction can create stress on components, particularly if welded joints are used. The plate assembly 102 addresses these thermal expansion/contraction issues with a design that both allows expansion/contraction of components without causing stress, and by maintaining contact between the plate assembly 102 and the cooling channel 112 for efficient heat transfer.

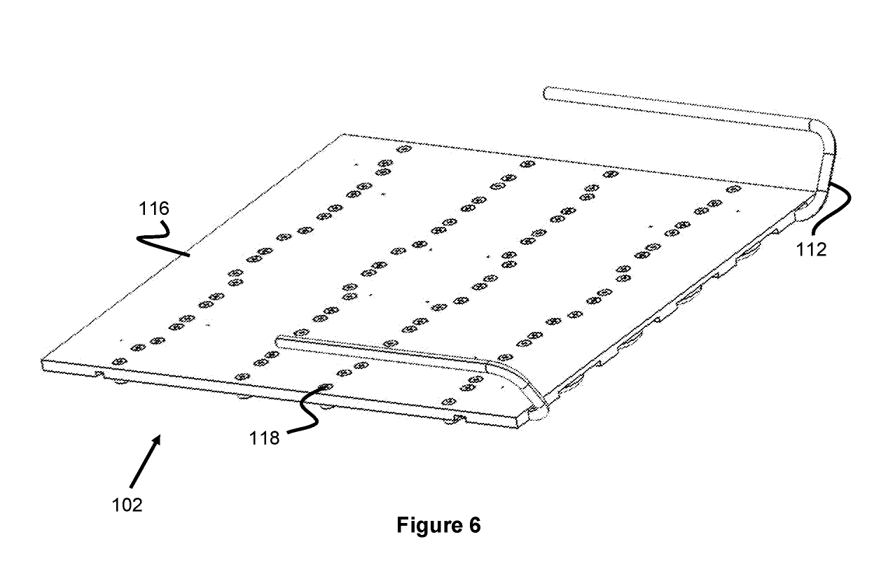

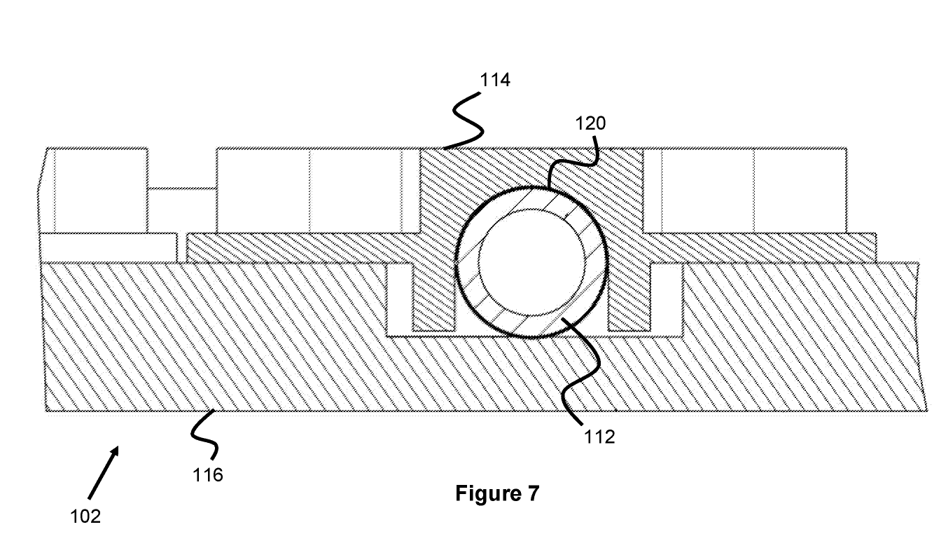

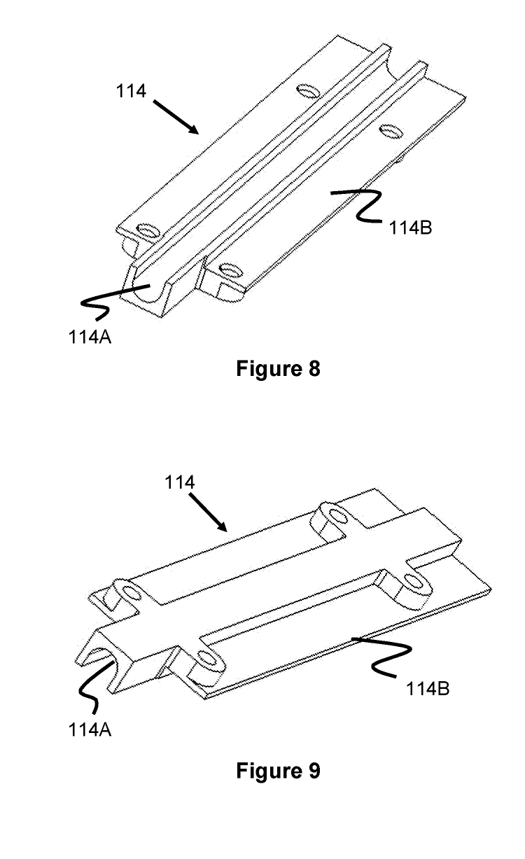

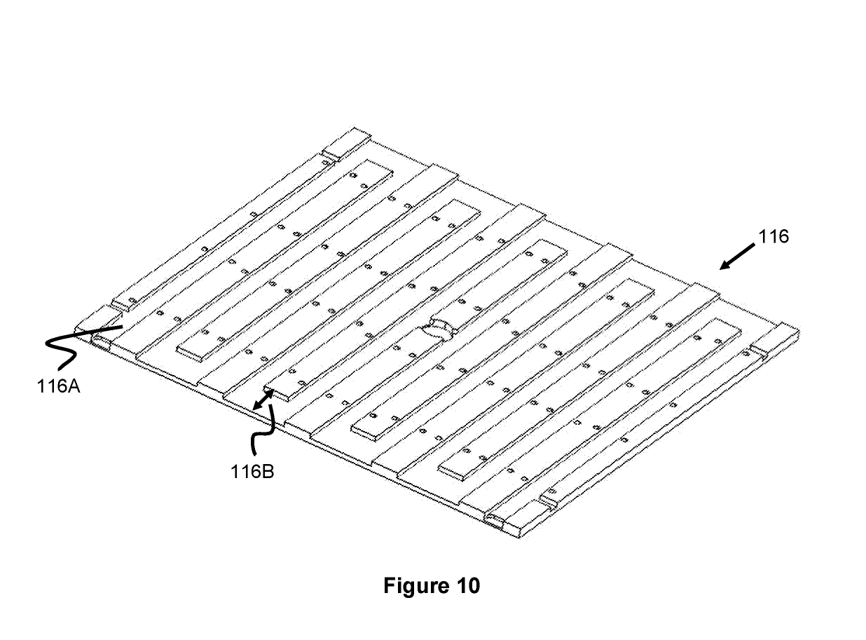

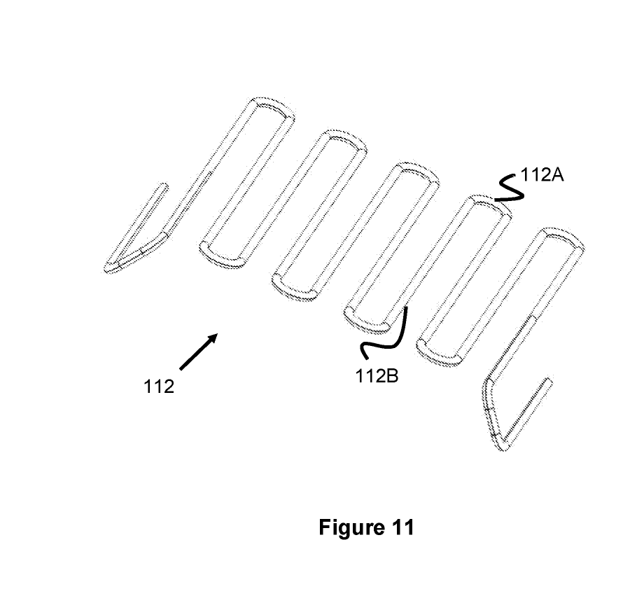

The plate assembly 102 includes a plate member 116 having a generally flat top surface (FIG. 6) that provides a work surface for placement of electronic workpieces. The bottom surface of the plate member 116 includes a plurality of parallel, grooves or recessed areas 116A (e.g., 10 channel) that are aligned along the width of the plate member 116 (FIG. 10), in which the cooling channel 112 is positioned. Specifically, the cooling channel 112 has a plurality of relatively straight regions 112B that are connected by a plurality of curved regions 112A (FIG. 11). The curved regions 112A are curved about 180 degrees and are connected in an alternating pattern, such that the straight regions 112B form a generally uniform and parallel pattern. The straight regions 112B are positioned in the recessed areas 116A of the plate member 116, while the alternating curved regions curve around a recessed end area 1166. Since the recessed areas 116A are located at the edge of the plate member 116, the cooling channel 112 are provided room to longitudinally expand and contract during heating and cooling without imparting undue stress on the plate assembly 102 components.

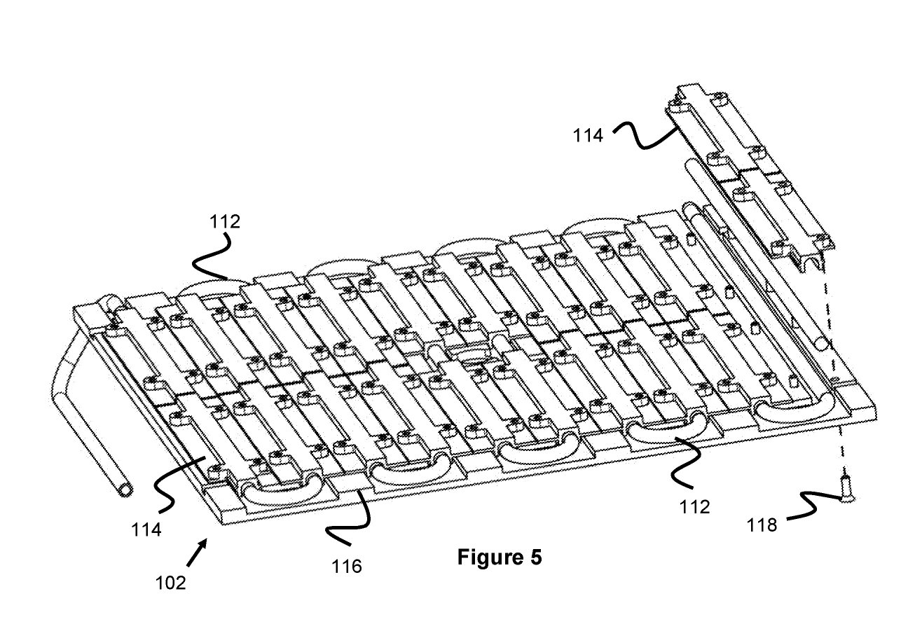

The cooling channel 112 is further held against the plate member 116 by a plurality of clamp plates 114, as seen in FIG. 5. Each clamp plate 114 includes a relatively straight groove 114A having a rounded bottom, shaped with a similar arc to that of the cooling channel 112 and thereby allowing the clamp plate 114 to mate with the straight region 112B of the cooling channel 112. In this respect, the groove 114A and the recessed area 116A form an enclosed passage for the cooling channel 112. Further, the use of screws 118 to secure the clamp plates 114 further reduces any stress-related damage that might be otherwise cause if the components were instead welded together.

The clamp plate 114 also includes flange portions 114B along each side of the groove 114A. The flange portions 114B include apertures (e.g., two on each flange portion 1146) that can be aligned with apertures through the plate member 116, allowing screws to be screwed through both to secure both components together, as seen in FIG. 5. In one embodiment, each straight, recessed area 116A accommodates two linearly adjacent clamp plates 114. However, different numbers of linearly adjacent clamp plates are possible (e.g., 1, 3, 4, 5, of 6).

As best seen in the cross-sectional view of the plate assembly 102, the straight region 112B (and optionally the curved regions 112A) of the cooling channel 112 are wrapped with one or more layers of a thermally conductive sheet 120 (e.g., a copper sheet or similar thermally conductive material). During cooling, the cooling channel 112 may radially contract to a greater extent than the plate assembly 102 (i.e., the plate member 116 and the clamp plates 114). However, the thermally conductive sheets 120 tend to bridge this displacement, maintaining an efficient heat conduction path between the cooling channel 116 and the plate assembly 102.

In one example embodiment, the plate member 116 and clamp plates 114 are composed of graphite, the cooling channel is composed of stainless steel, and the thermally conductive sheets 120 are composed of copper. Additionally, the coolant circulating through the coolant channel is water or air. In another example embodiment, the plate member 116 has a length of 30 cm and a width of 30 cm (though a wide range of sizes are possible according to the present invention).

In operation, a user programs the vacuum pressure furnace with a “recipe” or program specifying one or more periods of a desired heating temperature, pressure (or lack thereof), and cooling temperature. A workpiece is added to the chamber 104 and placed on the top surface of the plate assembly 102. The lid 106 is closed over the chamber 104 and the program is executed. The workpiece can, for example, be an electronic substrate, a cover disposed on the substrate, and solder material in between the two. In another example, the workpiece can be a silicon wafer being annealed.

In one example program, the chamber 104 is reduced to a low or vacuum pressure, and the heating elements 110 are activated to increase the temperature of the workpiece accordingly. Next, the heating elements 110 are deactivated and the vacuum pressure is either maintained or a specific gas is delivered into the chamber 104. Finally, cooling media is circulated through the cooling channel 112, reducing the temperatures of the outer portion of the channel 112. This reduced temperature is conducted through thermally conductive sheet 120 and on to the plate assembly 102. Finally, the reduced temperature of the plate assembly 102 is conducted to the workpiece.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A pressure vacuum furnace comprising:
a furnace chamber;
a cooling channel at least partially disposed within said furnace chamber;
a target plate member positioned over said cooling channel; and,
a plurality of clamp members positioned beneath said cooling channel and being fixed to a bottom surface of said target plate.

2. The pressure vacuum furnace of claim 1, further comprising one or more thermal sheets disposed around said cooling channel, so as to bridge any gaps between said cooling channel, said target plate member, and said plurality of clamp members.

3. The pressure vacuum furnace of claim 1, wherein said target plate comprises a plurality of parallel, elongated, recessed areas; and wherein straight portions of said cooling channel are positioned in said parallel, elongated, recessed areas.

4. The pressure vacuum furnace of claim 3, wherein each of said plurality of clamp members further comprises an elongated groove aligned with said straight portions of said cooling channel.

5. The pressure vacuum furnace of claim 4, wherein each of said plurality of clamp members further comprise flange portions extending on each adjacent side of said elongated groove; and wherein said flange portions are connected to said target plate member.

6. The pressure vacuum furnace of claim 5, wherein said cooling channel forms a plurality of parallel straight regions connected by a plurality of curved regions of alternating, opposite directions.

7. A pressure vacuum furnace comprising:
a furnace chamber;
a cooling tube at least partially disposed within said furnace chamber and configured to selectively circulate liquid coolant media therethrough; and,
a target plate assembly positioned over and around said cooling tube; said target plate assembly having a plurality of passages through which said cooling tube passes; wherein said plurality of passage are configured to allow longitudinal expansion and contraction of said cooling tube.

8. The pressure vacuum furnace of claim 7, wherein said target plate assembly further comprises a top plate member disposed over said cooling tube and a plurality of removable clamp plates fixed under said cooling tube.

9. The pressure vacuum furnace of claim 8, further comprising metal foil disposed between said top plate member and said cooling tube.

10. The pressure vacuum furnace of claim 9, wherein said metal foil is disposed between said clamp plate and said cooling tube.

11. A cooling assembly for a pressure vacuum furnace comprising:
a cooling channel at least partially disposed within said furnace chamber;
a target plate member positioned over said cooling channel; and,
a plurality of clamp members positioned beneath said cooling channel and being fixed to a bottom surface of said target plate.

12. The cooling assembly of claim 11, further comprising one or more thermal sheets disposed around said cooling channel, so as to bridge any gaps between said cooling channel, said target plate member, and said plurality of clamp members.

13. The cooling assembly of claim 11, wherein said target plate comprises a plurality of parallel, elongated, recessed areas; and wherein straight portions of said cooling channel are positioned in said parallel, elongated, recessed areas.

14. The cooling assembly of claim 13, wherein each of said plurality of clamp members further comprises an elongated groove aligned with said straight portions of said cooling channel.

15. The cooling assembly of claim 14, wherein each of said plurality of clamp members further comprise flange portions extending on each adjacent side of said elongated groove; and wherein said flange portions are connected to said target plate member.
